(19) United States
(12) Patent Application Publication
(10) Pub. No.: US 2006/0203740 A1
(43) Pub. Date: Sep. 14, 2006

(54) METHOD AND RELATED APPARATUS FOR MONITORING SYSTEM BUS

(76) Inventors: Nai-Shung Chang, Taipei Hsien (TW); Chia-Hsing Yu, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/162,608

(22) Filed: Sep. 16, 2005

(30) Foreign Application Priority Data
Mar. 8, 2005 (TW) 094106946

(51) Int. Cl. H04L 1/00

(52) U.S. Cl. 370/252

(57) ABSTRACT

Method and related apparatus for monitoring access modules, like memory or input/output modules, linked with a system bus of a computer system. In the present invention, access modules to be monitored and their corresponding monitoring intervals are preset. When a given access module initiates information exchange via the system bus, it is checked to see if the given access module matches any of the access modules to be monitored. If a match is found, a countdown is started from the corresponding monitoring interval. If the given access module completes the information exchange before the countdown finishes, the given access module is determined to be normal. Otherwise, a predetermined timeout event is executed for responding to a potential problem of the given access module.

### BACKGROUND OF THE INVENTION

1. Field of the Invention

The present invention relates to a method and related apparatus for monitoring a system bus, and more particularly, to a method and related apparatus capable of being programmed, selecting an object to monitor (monitored object), adjusting an interval during which the monitoring takes place (monitored interval), and selecting an appropriate response (monitoring response event.)

2. Description of the Prior Art

Due to the dramatic development of information technology, computer systems have been applied to a variety of fields and become one of the most important hardware structures in modern information society. In general, a computer system comprises a central processing unit (CPU), a memory, and a plurality of input/output modules for directing a variety of peripheral devices in order to realize multiple functions of the computer system. For example, some input/output modules are designed to handle an input function of a keyboard or a mouse, so that a user is allowed to input user instructions to the computer system. Other input/output modules, such as sound cards and display cards, are designed to control audio/video outputs of the computer system. A management interface of a hard disk or an optical disk allows the computer system to access non-volatile memory resources of the hard disk and the optical disk. Some input/output modules are designed to manage a network access interface, so that the computer system is allowed to access network resources. In an industrial computer system, specially designed input/output modules are used to manipulate a variety of industrial equipment, such as automated production, quality control, and fire security equipment.

In practice, an input/output module, regardless of its type, is connected to a system bus, so as to be connected to memory and a CPU. Through the interconnection realized by the system bus, the memory, the CPU, and the input/output module, they can exchange information, in order to integrate and realize all the functions of the computer system. For example, when the CPU is in operation, such as executing programs, some data stored in the memory can be transferred via the system bus to the input/output module to be displayed in audio/video form in front of users, to be stored, or to be transferred to a network or other peripheral devices. Messages/instructions input by users, and messages about the peripheral devices as well, can be transferred via corresponding input/output modules or the system bus to the memory, so that the CPU can manipulate the computer system based on the messages/instructions. Moreover, each of the input/output modules can use the system bus to access the memory directly, i.e. direct memory accessing.

In order to maintain the order of information exchange on the system bus between the CPU, the memory, and the input/output modules, the interconnection realized by the system bus is designed to obey a specific interconnection management agreement, such as a peripheral communication interconnection (PCI) management agreement. Any input/output module connected to the system bus must exchange information based on the interconnection management agreement.

Although the interconnection management agreement of the system bus sets a standard that any access module, including input/output module and memory, has to obey when performing information exchange, the interconnection management agreement does not monitor the operation of the input/output module. For example, under the interconnection management agreement, if an access module A makes a request that another access module B has to provide information, the access module B asks to acquire permission to use the system bus to provide information. If the access module B cannot provide the information that the access module A needs immediately, the access module B, according to the agreement, has to release the privilege to use the system bus, so that other access modules may use the system bus. The access module A is allowed to keep trying until the access module B is ready to provide information. Since the interconnection management agreement is designed to focus on whether any access module alone occupies the system bus over a predetermined period, the agreement does not monitor a certain access module to determine whether that certain access module has released the privilege to use the system bus, nor gives any corresponding response to an access module, which may or may not have released the privilege to use the system bus.

That is to say, the interconnection management agreement of the system bus cares only whether or not the flow of the system bus is obstructed, but does not care or even give any response depending on whether or not a certain access module is performing information exchange normally. If a certain access module cannot complete information exchange normally, as long as the access module releases the privilege to use the system bus, the interconnection management agreement assumes the access module is a normal access module linked with the system bus. However, when an access module cannot complete information exchange normally, the access module (or a peripheral module managed by the access module) has probably malfunctioned. If still using the prior art's interconnection management agreement, such a malfunction cannot be detected. For example, if an access module happens to be malfunctioning while performing information exchange with another access module, the interconnection management agreement is still functioning normally, without providing any response in reaction to the malfunction of the access module. Therefore a user, and the computer system as well, are not able to notice the malfunctioned access module, nor give any corresponding remedy in time. Ultimately, the functions of the entire computer system may become abnormal, and cause great industrial danger.

In summary, in the prior art, the system bus depends on nothing but the interconnection management agreement to maintain the operation of the system bus. The interconnection management agreement is not capable of monitoring the information exchange of a certain access module. Therefore, it cannot monitor the operation of any access module through the monitoring of the information exchange between the access module and other access modules, nor by making any announcements, records or giving a response when the information exchange is abnormal.

### SUMMARY OF THE INVENTION

It is therefore a primary objective of the claimed invention to provide a monitoring mechanism, which can be programmed to select a certain monitored access module as well as select its corresponding monitoring intervals and response events. While these access modules are performing information exchange via a system bus, the monitoring mechanism of the claimed invention has the capability to monitor whether the certain access module is performing the information exchange normally, and execute the corresponding response event according to a monitoring result. Whether the access module is functioning normally can be determined according to the information exchange performed by the access module, so as to overcome the above-mentioned problems.

A method of the claimed invention monitors a system bus linked with a plurality of access modules. The access modules perform information exchange via the system bus. The method includes: while one of the access modules is performing information exchange, and conforms to an address range, loading a corresponding monitoring interval, beginning a countdown process, and if the access module has not completed the information exchange when the countdown process of the monitoring interval finishes, executing a corresponding timeout event.

An apparatus of the claimed invention monitors a system bus linked with a plurality of access modules. The access modules perform information exchange via the system bus. The apparatus includes a monitoring module connected to the system bus for monitoring the information exchange of the access modules on the system bus, an address register module connected to the monitoring module for storing address ranges of the access modules, a monitoring interval register module for storing a monitoring interval during which the access module is monitored, and a counter for counting the monitoring interval, wherein when the access module, which conforms to the address range stored in the address register, is performing information exchange, loading the monitoring interval corresponding to the access module, and executing a countdown process.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a monitoring mechanism applied to a computer system according to the present invention.

FIG. 2 is a flow chart demonstrating the operation of the monitoring mechanism shown in FIG. 1.

FIG. 3 is a timing diagram of the monitoring mechanism shown in FIG. 1 when the computer system is in operation.

### DETAILED DESCRIPTION

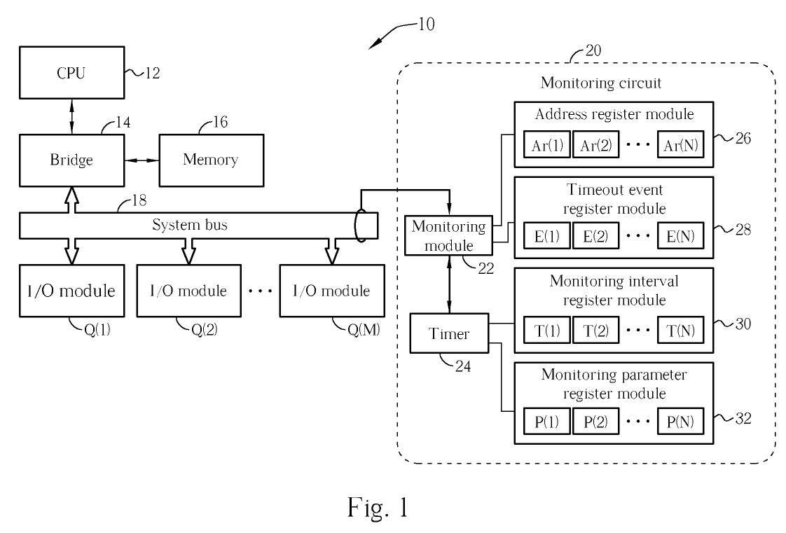

Please refer to FIG. 1, which is a functional block diagram of a monitoring mechanism applied to a computer system 10 according to the present invention. The computer system 10 comprises a CPU 12, a bridge 14 (such as a chipset or a north bridge circuit), a memory 16 (such as DRAM), a system bus 18 (such as any system bus obeying the PCI management agreement, i.e. a PCI bus), and one or more input/output (I/O) modules Q(1) to Q(M). The CPU 12 is in charge of operating the computer system 10, like executing programs, and calculating data. The memory 16 stores information and programs needed by the computer system 10 and the CPU 12 to operate. Via the bridge 14, the CPU 12 and the memory 16 are capable of performing information exchange with the I/O modules. The I/O modules can be management circuits of a keyboard/mouse, processing circuits capable of controlling outputs of the computer system 10, management interface circuits of hard disks and optical disks, or management interface circuits of automated production, quality monitoring or fire security equipment.

In general, the operation of the interconnection of the system bus functions as follows: The access modules, which can be I/O modules or memory, are all connected to the system bus 18. Each has its own identification address range. When an access module A is going to exchange information, such as instructions and/or messages, with another access module B, the access module A can broadcast the access module B's address range onto the system bus 18. After receiving the broadcasted address range, the access module B compares the address range with its own identification address range, and determines whether or not it is the access module with which the access module A is going to exchange information. Then, the access module B begins to perform a hand-shaking process with the access module A, and then to perform an information exchange. During the period when the information exchange is being performed, both the access module A and the access module B can make use of an ack/nack process (transmission control characters) to identify whether the information exchange is being performed normally, and release the system bus after the information exchange is completed.

In order that the monitoring mechanism of the present invention can be realized on the system bus 18, the computer system 10 further comprises a monitoring circuit 20, such as a system bus monitoring circuit of the present invention. The monitoring circuit 20 comprises a monitoring module 22, a timer 24, an address register module 26, a timeout event register module 28, a monitoring interval register module 30, and a monitoring parameter register module 32. The monitoring module 22 monitors signals traveling over the system bus 18, receives address ranges broadcasted on the system bus 18, and determines whether a certain information exchange is completed by monitoring the hand-shaking process and the ack/nack process. The address register module 26 is capable of storing one or more identification address ranges of access modules to be monitored. As shown in FIG. 1, the address register module 26 stores N address ranges Ar(1) to Ar(N). That is, there are N access modules having the address ranges Ar(1) to Ar(N) which are to be monitored. Any one of the access modules has a corresponding monitoring interval (the length of time during which it should be monitored while making a given information exchange). The monitoring interval register module 32 is installed to store the access modules Ar(1) to Ar(N)'s corresponding monitoring intervals. The timer 24 can be loaded with one of the monitoring intervals and, triggered by the monitoring module 22, start to count down the loaded monitoring interval. The timeout event register module 28 stores the access modules' corresponding timeout events E(1) to E(N). The monitoring parameter register module 32 stores monitoring parameters (such as the monitoring intervals) of the access modules.

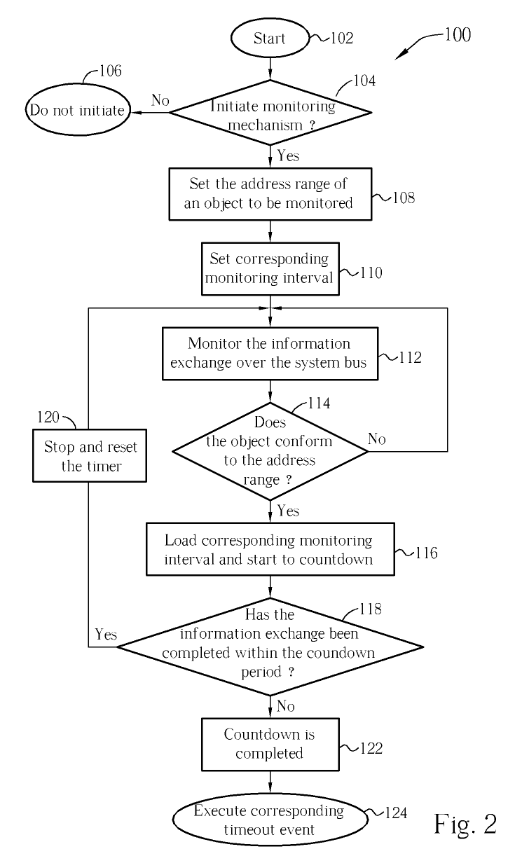

In order to demonstrate the operation of the monitoring mechanism of the present invention, please refer to FIG. 2, and FIG. 1 as well. FIG. 2 is a flow chart demonstrating the monitoring mechanism of the present invention. The flow chart 100 shown in FIG. 2 comprises the following steps:

Step 102: Start. The flow chart 100 starts as soon as the computer system 10 is booting.

Step 104: Determine whether to initiate the monitoring mechanism of the present invention. In practice, the present invention uses a basic input/output system (BIOS) of a computer system to realize a user interface, so that the user is able choose whether or not to initiate the monitoring mechanism of the present invention by changing the BIOS. For example, the user can enter a setup interface of the BIOS when the computer system is booting. The present invention can add a selection item to the setup interface for the user to determine whether or not to initiate the monitoring mechanism of the present invention. If yes, go to step 108. If no, go to step 106.

Step 106: The user determines not to initiate the monitoring mechanism, and the flow chart 100 ends.

Step 108: If the user determines to initiate the monitoring mechanism, in this step he can set an object to be monitored (monitored object), that is, an access module to be monitored (monitored access module), which could be memory and/or input/output modules. In practice, an identification address range of the monitored access module is stored/written to the address register module 26. Similar to step 104, this step can be realized through the use of BIOS. For example, adding selection items for the user to select which objects are to be monitored.

Step 110: Set the monitored access module's monitoring interval. That is, write/store the monitored access module's monitoring interval to the monitoring interval register module 30. Moreover, in this step, the user can appoint the monitored access module's corresponding timeout event and other monitoring parameters, that is, write/store the monitored access module's corresponding timeout event and other monitoring parameters to the timeout event register module 28 and the monitoring parameter register module 32 respectively.

Similar to step 108, this step can be realized through the use of the setup interface of BIOS. The user can select/set on the setup interface of BIOS the monitoring interval of the monitored access module, and the monitoring interval register module can be used to store the selected monitoring interval. As far as the timeout event is concerned, the present invention can provide a variety of practicable events, each of which has its own code. The user selects a timeout event for a monitored object Ar(n), the timeout event having a code and the code serving as a timeout event code E(n) of the monitored object, and stores/writes the code to the timeout event register module 28. Similarly, the present invention can provide more options for the monitoring parameter to the setup interface of BIOS, and what the user selects can be stored/written to the monitoring parameter register module 32. After completing this step, the computer system completes the booting process, and is able to perform its functions. The flow chart 100 goes to step 112.

Step 112: After the computer system 10 has completed the booting process, the monitoring module 22 starts to monitor signals traveling over the system bus 18. When the monitoring module 22 monitors that an identification address range of a certain access module is broadcasted on the system bus 18, the monitoring module 22 proceeds to step 114.

Step 114: Perform an identification process. When the monitoring module 22 monitors that the access module's identification address range has been broadcasted on the system bus 18 and learns that the access module is going to perform information exchange, the monitoring module 22 determines if the broadcasted address range is identical to any of the address ranges Ar(1) to Ar(N) stored in the address register module 26. If the broadcasted address range conforms to a monitored address range, say Ar(n), indicating that a monitored access module is going to perform information exchange, then the flow chart 100 proceeds to step 116. If the broadcasted address range conforms to none of the address ranges Ar(1) to Ar(N), indicating that an access module that the broadcasted address range corresponds to is not an object to be monitored, then the flow chart 100 goes back to step 112, and the monitoring module 22 keeps monitoring the system bus 18.

Step 116: Perform a timing process. That step 114 proceeds to step 116 represents that the identification address range broadcasted on the system bus conforms to one of the address ranges, say the monitored address range Ar(n), and that the monitored object Ar(n) is going to perform the information exchange over the system bus 18. Then, a corresponding monitoring interval T(n) is loaded from the monitoring interval register module 30 to the timer 24. As soon as the monitoring module 22 monitors that the information exchange begins, the timer 24 starts to count backwards from the countdown monitoring interval T(n).

Step 118: During a period when the timer 24 is counting, the monitoring module 22 keeps monitoring whether the monitored object Ar(n) has completed the information exchange with another access module successfully. If the information exchange is finished successfully before the timer 24 has completed the timing process, that is, before the countdown monitoring interval T(n) is counted backwards to zero, it indicates that the monitored object Ar(n) can perform information exchanges with other access modules successfully. The flow chart 100 then proceeds to step 120. However, if the information exchange is still in progress when the timer 24 has completed the timing process, the flow chart 100 proceeds to step 122.

Step 120: If the monitored object Ar(n) has completed the information exchange before the timing process is finished, the timing process can be stopped in this step. Thus the timer 24 is reset, and the flow chart 100 goes back to step 112, to wait for the next monitoring process.

Step 122: If the monitored object Ar(n) cannot complete the information exchange before the timing process is over, indicating that it lacks the capability to complete the information exchange within the monitoring interval T(n), and that it has malfunctioned, then the flow chart 100 proceeds to step 124.

Step 124: The monitored object Ar(n) cannot complete the information exchange within its corresponding monitoring interval, indicating that its information exchange goes past a time limit (the monitoring interval T(n)). The monitoring module 22 looks for the monitored object Ar(n)'s corresponding timeout event code E(n) in the records stored in the timeout event register module 28, and executes a timeout event corresponding to the timeout event code E(n). For example, the monitoring module 22 reports an interrupt to the CPU 12, or records the abnormal information exchange of the monitored object Ar(n). After completing the timeout event, the flow chart 100 goes back to step 112, and keeps monitoring information exchange over the system bus 18.

It can be seen from the above description that the monitoring mechanism of the present invention can keep monitoring if a monitored object (input/output module or memory) is going to perform information exchange over the system bus (steps 112 and 114), and how long the monitored object needs in order to perform the information exchange (steps 116 and 118).

If the information exchange is completed within a reasonable time limit, the monitoring mechanism keeps monitoring information exchange over the system bus (steps 120 and 112). If the monitored object does not complete the information exchange within the reasonable time limit, the corresponding timeout event is executed to respond/inform/record that the information exchange is abnormal. The reasonable time limit is determined by the timer 24 counting down a monitoring interval. After a time interval is determined to be the time needed to complete the information exchange successfully, the monitoring interval can be a little bit longer than the time. A user is able to set a monitored object's corresponding monitoring interval according to operating characteristics of the monitored object.

Additionally, with respect to selecting a monitoring object, the system bus 18, no matter which interconnection management agreement it obeys, must have a specific addressing mode to identify access modules, or even to identify a single access module's sub-function circuits or sub-blocks. In the present invention, an address range, as long as it is acknowledged by the interconnection mechanism, can serve as a monitored object, whose corresponding identification address range is stored to the address register module 26. For example, under a certain interconnection mechanism, an access module B has two sub-function circuits B1 and B2 having two independent addresses. Other access modules can exchange information with the sub-function circuit B1 (not with the sub-function circuit B2), or with the sub-function circuit B2 only, independently. Under such a circumstance, the present invention serves the sub-function circuits B1 and B2 as two distinct objects. In detail, the present invention can monitor the sub-function circuit B1 only, but ignore the sub-function circuit B2, and record an identification address range of the sub-function circuit B1, not of the sub-function circuit B2, to the address register module 26. Equivalently, the access module B has two independent logic access modules. If, under the interconnection mechanism, each memory unit of certain memory can be addressed individually, then each memory unit can be regarded as an object, and the address range of the memory can be divided into a plurality address ranges of individual objects to be monitored.

In the present invention, in addition to the execution of the timeout events, if the information exchange is not over the time limit, some non-timeout events can be executed. The monitoring circuit 20 (shown in FIG. 1) can have a specially designed register module, that is, a non-timeout event register module, to store a non-timeout event (not shown in FIG. 1) corresponding to a monitored object, the non-timeout event being executed in step 120 (during a period when the monitored object completes the information exchange successfully).

To realize the present invention, the monitoring parameters corresponding to the monitored objects are used to increase the flexibility of a monitoring process. For example, when the timer 24 is counting, the length of monitoring intervals of different monitored objects can be represented by a variety of counting intervals. If a monitored object has a corresponding counting interval equal to one millisecond, and a corresponding monitoring interval equal to 120 counting intervals, the timer 24, when monitoring the monitored object, counts backwards from 120 and decreases once every millisecond. That is, the monitoring interval is equal to 120 milliseconds. On the other hand, if a countdown interval of another monitored object is 30 micro seconds, and the monitored object's corresponding monitoring interval is 120 counting intervals, the timer 24, when monitoring the monitored object, backward counts from 120, but decreases once every 30 micro seconds. That is to say, the monitored object's corresponding monitoring interval is equal to 3,600 (=30×120) milliseconds. The counting interval corresponding to each of monitored objects is recorded in the monitoring parameters, which are loaded to the timer 24 in step 116, and the timer 24 therefore counts according the counting interval. Moreover, the monitoring parameters can comprise other detail adjusting parameters, which can be loaded to the timer 24 in step 116 to adjust monitoring details during a monitoring period.

In addition to using BIOS to set the register modules of the monitoring mechanism of the present invention, the present invention, together with corresponding driving programs, lets a user adjust the contents of each of a plurality of register modules by complying with/adding/deleting monitored objects' corresponding monitoring intervals, timeout events, and other monitoring parameters through an operating system driven program interface after the computer has booted and an operating system is loaded to the computer system.

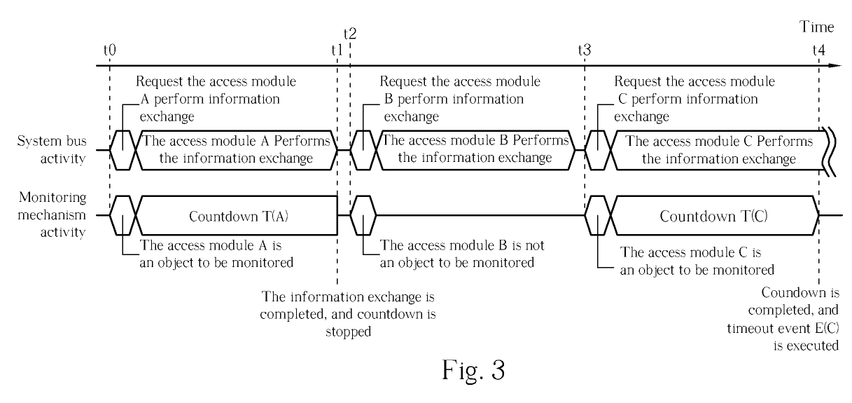

Please refer to FIG. 3, and FIG. 1 and FIG. 2 as well. FIG. 3 is a timing diagram of the monitoring mechanism of the present invention when the computer system 10 (shown in FIG. 1) is in operation, where an abscissa represents time. After the flowchart 100 (shown in FIG. 2) has completed the execution of steps 102 to 110 and the computer system 10 has already booted, the monitoring mechanism of the present invention starts to monitor signals traveling over the system bus 18. As shown in FIG. 3, at time t0, an access module is assumed to exchange information with another access module A. An identification address range of the access module A is then broadcasted over the system bus 18. The monitoring module 22 of the present invention checks whether the address range of the access module A conforms to any one of the address ranges stored in the address register module 26 (step 114 of the flow chart 100). If so, the access module A is assumed to be one of the plurality of monitored objects, when the access module A acquires permission to use the system bus 18 and starts to perform information exchange, the timer 24 is loaded with an access module A's corresponding monitoring interval T(A) from the monitoring interval register module 30 and starts timing (steps 114 and 116 of the flow chart 100). At time t1, the access module A completes a cycle of information exchange. If the timer 24 has not completed the counting process (counting backwards from the monitoring interval T(A) to zero), indicating that the time for the access module A to execute information exchange is less than the corresponding monitoring interval T(A), then the information exchange is normal. The timer 24 at time t2 stops counting and is reset. Then the flow chart 100 goes back to step 112, where the monitoring module 22 keeps monitoring the system bus.

After the access module A has completed the information exchange, the permission to use the system bus is released. At time t2, another access module B requests to perform information exchange. The monitoring module 22 then starts to check whether the access module B is a monitored object (steps 112 and 114 of the flow chart 100). Since the access module B is not one of the monitored objects, the monitoring mechanism ignores the access module B and does not perform the counting process. The flow chart 100 proceeds from step 114 to step 112, where the monitoring module 22 keeps monitoring activities performed over the system bus. After the access module B has completed the information exchange, the system bus is accordingly released.

At time t3, another access module C is requested to perform information exchange. The monitoring module 22 determines whether the access module C is one of the monitored objects according to an address range broadcasted over the system bus (steps 112 and 114 are executed again). Since the access module C is indeed a monitored object, the timer 24 loads the access module C's corresponding monitoring interval T(C) and starts to count backwards. At time t4, the timer 24 has completed the counting process (for example counting backwards from the monitoring interval T(C) to zero), but the monitoring module 22 determines that the access module C has not completed the information exchange, and so reads a timeout event code E(C), corresponding to the access module C, from the timeout event register module 28, and triggers the execution of the timeout event. For example, the monitoring module 22 reports an interrupt signal to the CPU 12, or informs about, responds to, or records this abnormal information exchange.

In summary, the prior art can only operate according to the interconnection management agreement, and monitor accessing behavior of a certain access module over the system bus. In contrast, the present invention can provide a monitoring mechanism to monitor the situation of an access module via its ability to perform information exchange over the system bus, so that the computer system/a user can take immediate action in response to any abnormality and help the computer to function normally. Since the system bus is one of the most important channels to exchange information between a variety of important components (CPU, memory, and input/output modules), the monitoring of the system bus of the present invention can reflect the situation of these important components of the computer system, and monitor the behavior of these important components. Moreover, the monitoring mechanism of the present invention has the following advantages: First, the monitoring mechanism can be realized by low-cost hardware circuits, or can be integrated into a chipset. Second, the present invention has an impressive compatibility. Since the present invention is designed to monitor the system bus passively, it neither reduces the operating efficiency of the system bus, nor consumes the operating resources of the computer system. The present invention further has remarkable application flexibility, allowing users to select and control a monitored object and its corresponding monitoring details (such as a monitoring interval). In conclusion, the present invention can be applied to a variety of computer systems, to help the computer system to operate normally.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for monitoring a system bus linked with a plurality of access modules, the access modules performing information exchange via the system bus, the method comprising:
when one of the access modules is performing information exchange and conforms to an address range, loading a corresponding monitoring interval and beginning to execute a countdown process; and
if the access module has not completed the information exchange when the countdown process of the monitoring interval is finished, executing a corresponding timeout event.

2. The method of claim 1 further comprising:
setting at least an address range of the access module to be monitored as well as the corresponding monitoring interval when initiating.

3. The method of claim 1 further comprising:
setting the timeout event of the access module to be monitored when initiating.

4. The method of claim 1 further comprising:
setting a monitoring parameter of the access module to be monitored when initiating.

5. The method of claim 4, wherein the monitoring parameter is a counting interval of the monitoring interval.

6. The method of claim 5, wherein the counting intervals are capable of representing a length of the monitoring interval of the access module.

7. The method of claim 1, wherein the timeout event is an interrupt.

8. The method of claim 1, wherein if the access module has completed the information exchange before the countdown process of the monitoring interval is finished, stopping counting and resetting the monitoring interval.

9. The method of claim 8 further comprising executing a non-timeout event.

10. The method of claim 9 further comprising:
setting the non-timeout event of the access module to be monitored when initiating.

11. An apparatus for monitoring a system bus linked with a plurality of access modules, the access modules performing information exchange via the system bus, the apparatus comprising:
a monitoring module connected to the system bus for monitoring the information exchange of the access modules on the system bus;
an address register module connected to the monitoring module for storing an address range of the access module;
a monitoring interval register module for storing a monitoring interval during which the access module is monitored; and
a counter for counting the monitoring interval,
wherein when the access module, which conforms to the address range stored in the address register, is performing information exchange, loading the monitoring interval corresponding to the access module, and beginning to execute a countdown process.

12. The apparatus of claim 11 further comprising:
a timeout event register module connected to the monitoring module for storing at least a timeout event,
wherein if the access module has not completed the information exchange when the counter has completed the countdown process, executing the corresponding timeout event.

13. The apparatus of claim 12, wherein the timeout event is an interrupt.

14. The apparatus of claim 11, wherein the counter stops counting when the access module has completed the information exchange.

15. The apparatus of claim 11 further comprising:
a non-timeout event register module connected to the monitoring module for storing at least a non-timeout event, which is executed if the access module has completed the information exchange before the counter has completed the countdown process.

16. The apparatus of claim 11 further comprising:
a monitoring parameter register module connected to the counter for storing a monitoring parameter.

17. The apparatus of claim 11, wherein the monitoring parameter is a counting interval of the monitoring interval.

18. A method for monitoring a system bus linked with a plurality of access modules, the access modules performing information exchange via the system bus, the method comprising:
selecting at least a target access module from the access modules;
setting a monitoring interval of the target access module; and
counting a time for the target access module to perform an information exchange while the target access module is performing the information exchange,
wherein when the time is longer than the monitoring interval, executing a timeout event.

19. The method of claim 18, wherein the access module has a corresponding address range.

20. The method of claim 18, wherein if an address range of an access module that is performing an information exchange conforms to the address range of the target access module, the access module is determined to be the target access module.
